(19) United States
(12) Patent Application Publication
(10) Pub. No.: US 2010/0307382 A1
(43) Pub. Date: Dec. 9, 2010

(54) COMPUTERIZED SCHOOL DESK

(76) Inventors: Alaide Pellegrini Mammana, Campinas - SP (BR); Carlos Ignacio Zamitti Mammana, Campinas - SP (BR); Elias Teodoro Galante, Serrana - SP (BR); Miquel João Neto, Taquaritinga-SP (BR)

Correspondence Address: BUCHANAN, INGERSOLL & ROONEY PC, POST OFFICE BOX 1404, ALEXANDRIA, VA, 22313-1404, US

(21) Appl. No.: 12/864,144

(22) PCT Filed: Dec. 15, 2008
(86) PCT No.: PCT/BR08/00391

§ 371 Date: Jul. 22, 2010

(30) Foreign Application Priority Data
Dec. 14, 2007 (BR) PI070367-3

(51) Int. Cl. A47B 21/007; G06F 3/041; G06F 3/033; A47B 17/00; A47B 13/08; A47B 41/02

(52) U.S. Cl. 108/5; 345/173; 345/163; 108/1

(57) ABSTRACT

Computerized school desk for education and many other applications comprising a rigid structure to support a transparent tabletop (1) that has the functionality of a touch-operated screen under which is placed a computer flat panel display (3) attached to said screen, said apparatus being provided with a mechanism for tilting the tabletop from a position substantially horizontal and a position approximately vertical or any intermediate position. The referred mechanism consists of a pair of couplings that slide along two guides substantially horizontal and at least one connecting rod rotationally coupled to an intermediate point of the said tabletop between the front and rear borders of said tabletop and to other point fixed in the structure of the table, substantially coplanar with side guides.

### FIELD OF THE INVENTION

This invention describes a work station or desk which comprises a transparent tabletop with the functionality of a touch screen or tablet, an electronic display and a computer or equivalent information processing device. This work station or desk can be used for educational purposes but also in many other applications, offering an alternative way of interaction for making text or figures.

### STATE OF THE ART

Pedagogical equipment adaptable to all levels of education using interactive screens with and without the intervention of the teacher is known. An example of this kind of equipment is described in U.S. Pat. No. 5,730,602 “Computerized method and apparatus for teaching handwriting” that describes a method of learning cursive writing to children, using a digitizing surface that captures in real time, while drawing a letter, the coordinate values of the extremity of a pointer as well as its pressure over the surface and other parameters of interest. These data are sent to a computer that represent the drawing and compares it to data already stored that are considered “normal” or “ideal” in order to identify problems in the writing process in which case visual or auditory corrective information is transmitted to the student.

The apparatus described in the aforesaid document comprises a base in the form of a flat box with sufficient dimensions to accommodate the forearm of the student and in which the digitizing device is assembled that also serves as physical support for a flat LCD panel. Therefore the extremity of the pointer does not make direct contact with the surface of the digitizer since this contact is made through the LCD panel that transmits the force exerted by the student by means of the pointer resulting in a flexion of the afore mentioned panel.

A shortcoming of this assembly is that the successive deformations to which the panel is submitted accelerate its wear. Furthermore, the existence of an intermediate element between the pointer and the digitizing surface introduces inaccuracies in capturing the touch point coordinates. Furthermore, the described apparatus cannot be used independently of a support such as a table or similar furniture, in this way limiting its versatility for other uses such as, for example, its use as a table computer. Finally, the described apparatus cannot be used with flat panel displays normally found in the market, because these do not provide the transmission of the pressure put on the digitizer by the user.

### OBJECTS OF THE INVENTION

In view of the above considerations, the first object of the present invention is to provide an apparatus in the form of a desk that can embody the functionalities of a writing-desk, drawing board or workstation in which the top is a transparent screen driven by touch.

Another object is the provision of an apparatus that does not need to be supported on a table or similar.

Another object is the provision of an apparatus with means that allow adaptation to various configurations of use such as a conventional writing-desk or tiltable drawing board, in each case with the option of using a touch screen or tablet.

Another object consists of insuring that the user of the aforesaid computerized desk can use it with total comfort and fulfilling ergonomic requirements in either of the forms of use above described.

Another object of the invention is that it can be built according to the standard for school desks.

Another object of the invention is to provide means for information processing.

Another object of the invention is that its implementation can be made with low cost components and materials easily found in the market.

Another object is that it comprises a flat electronic display installed below the touch screen or tablet in such a way that display and touch screen can be moved smoothly together.

Another objective of the invention is that it can be implemented with flat electronic displays with any dimensions as far as these do not exceed those of the touch screen or tablet.

### SUMMARY OF THE INVENTION

The afore mentioned objectives as well as others are accomplished by the invention through the provision of an apparatus that comprises a sturdy support structure, a tabletop that comprises a transparent screen operated by touch or pointer under which is placed a flat panel display attached to the transparent screen, the whole assembly being provided with a mechanism for tilting from a completely horizontal position to an approximately vertical position or any intermediate position.

According to another feature of the invention, said mechanism comprises at least a coupling rod of which one extremity is rotationally coupled to an intermediate point between the anterior and posterior borders of the top and whose other extremity is rotationally coupled to a fixed point of the afore said structure, the coupling rod moving in a plane orthogonal to the plane of the tabletop, as well as two elements attached to the proximal region of the sides of the afore said tabletop coupled to two parallel sliding guides placed at the approximate height of the tabletop or school desk. The foregoing description is just one embodiment of the invention; many other mechanical constructions can fulfill the objectives of moving touch screen or tablet together with electronic display.

According to another feature of the invention said transparent screen presents functionalities of touch screen or digitizing tablet operating as an input device for data processing means.

According to another feature of the invention, such data processing means can be included in the table, for instance in the form of a computer operating autonomously or in a network.

According to another feature of the invention one computer can control several tables in said afore mentioned network.

According to another feature of the invention said tabletop surface can also be used as a conventional desk.

According to another feature of the invention said display is installed below the touch screen or tablet in such a way that display and touch screen can be moved smoothly together.

According to another feature of the invention said tabletop can be implemented with flat electronic displays with any dimensions as far as these do not exceed those of the touch screen or tablet.

According to another feature of the invention such structure comprises, immediately below said tabletop, a surface to be used for the support of objects of any nature optionally comprising a conventional mouse and keyboard.

According to another feature of the invention said tabletop has an adjustable inclination angle according to the needs of the user such as a drawing board of adjustable inclination. Advantageously, the tilting of the tabletop can be aided by providing an optional damper.

Optionally the displacement and the inclination can be controlled by the action of motors.

According to another feature of the invention the afore mentioned apparatus can be built with different heights and widths according to the age group of the users.

According to another feature of the invention such desk follows the standard model of school desks and complies with ergonomic requirements.

According to another feature of the invention said desk allows working with additional resources such a computer, books, copybooks and other objects.

### BRIEF DESCRIPTION OF THE DRAWINGS

Further objectives, features and advantages of the present invention will be best evaluated by the description of preferred embodiments of the invention, given as examples and by the figures to which they refer and in which:

FIG. 1 show the proposed apparatus constructed according to the principles of the invention. FIG. 1a shows the front view with the tabletop in the horizontal position and FIG. 1b the tabletop in the vertical position.

FIG. 2 shows the apparatus in a side view with the tabletop in an intermediate position.

FIG. 3 shows the apparatus in a perspective view with the tabletop in an intermediate position.

FIG. 4 shows the apparatus with the tabletop in a horizontal position when used with the touch screen or tablet or, also, as writing desk.

### DETAILED DESCRIPTION OF THE INVENTION

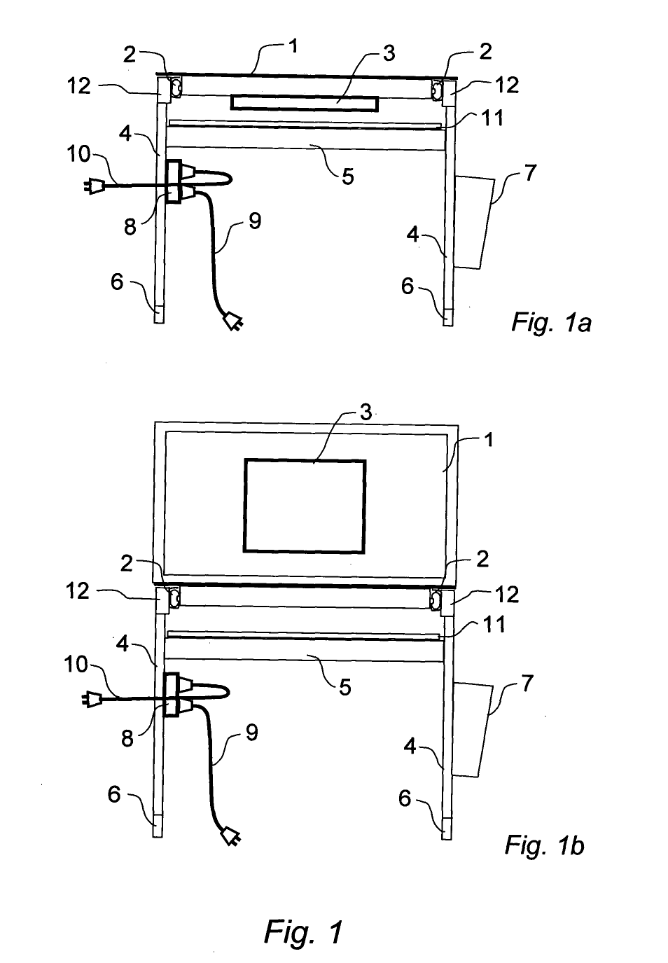

FIG. 1 shows two views of the construction of the proposed apparatus, showing that it is provided with a transparent tabletop (1) which is composed by a touch screen or tablet under which is mounted a flat panel display (3) that can be moved jointly with said screen or tablet. The screen of the mentioned flat panel display is completely visible through the transparent tabletop. The dimensions of the apparatus are about the same as those of a regular school desk.

In the exemplary embodiment shown, the tabletop (1) is fixed to the two longitudinal guides (12), parallel and substantially horizontal, by means of two small guide pulleys (2) placed at the left and right sides of the proximal edge of the tabletop, the said pulleys running inside of troughs fixed to the afore mentioned guides or, even, being an integral part of them.

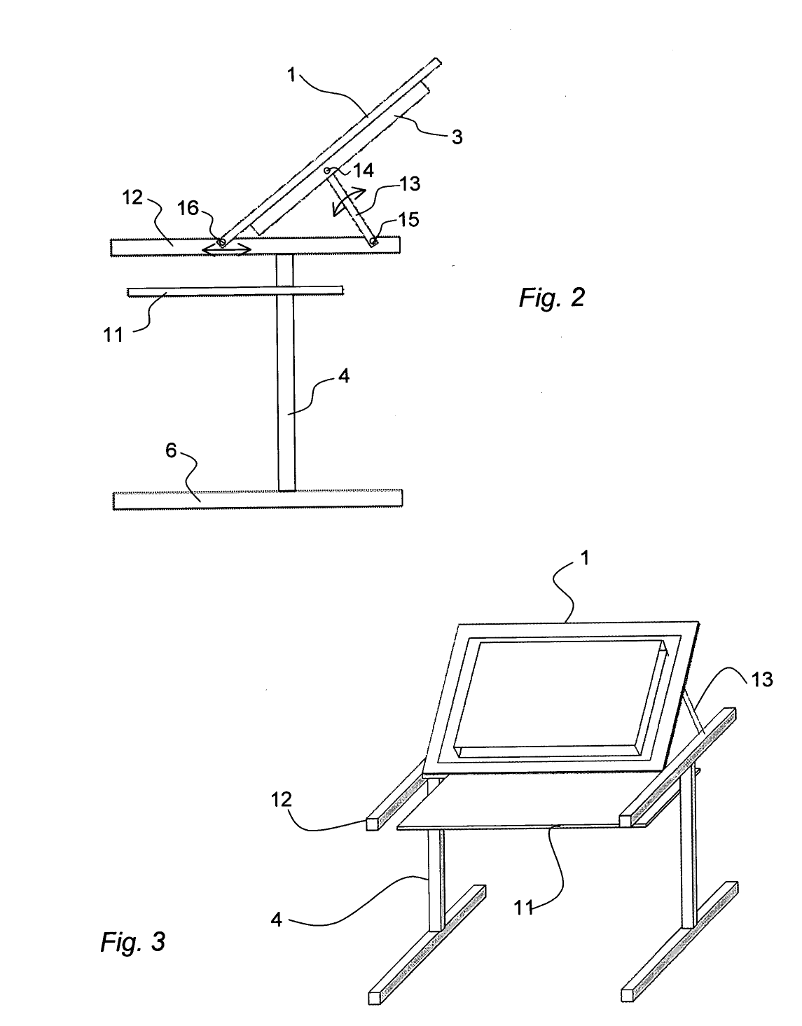

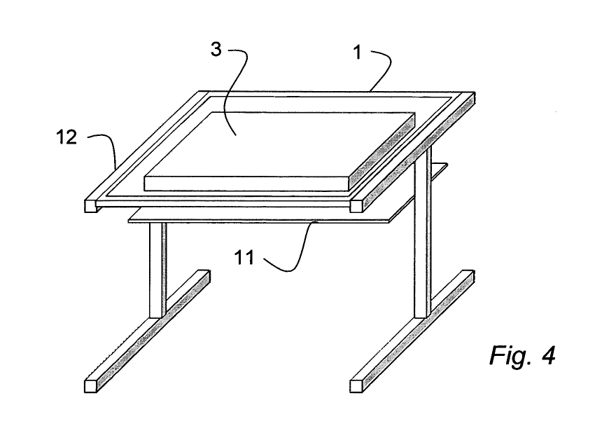

Two lateral coupling rods (13) linked in their extremities by means of rotational couplings (14) and (15), complete the tabletop tilting means. The coupling (14) is placed at the tabletop in a longitudinal position that is intermediate between the front and rear edges, while the coupling (15) is placed, in the embodiment of the example, at the rear region of the lateral guides (12). The change of position of the tabletop, from horizontal to intermediate and from this one to the vertical is provided by the displacement indicated symbolically by the two-pointed arrows in FIG. 2, said displacement being a linear sliding one in the case of the pulleys (2) and rotational for the coupling rod (13).

A damper fixed laterally may be optionally provided with the function of assist the movement of the tabletop. A transversal rod (5) provides structural reinforcement interconnecting the two legs (4) and is fixed in an elevated position to facilitate the cleaning of the floor under the apparatus. The desk is supported with transversal stay bars (6).

The proposed embodiment has, additionally, a supporting shelf for keyboard and mouse (11) placed under the tabletop (1) and a lateral support (7) fixed to the leg (4), to be used also to place school materials such as books, and notebooks. FIG. 2 shows, in schematic form, the position of the keyboard (17). In that figure an alternative embodiment is indicated, in which the support (11) may be slid in the horizontal direction to the position (11′), closer to the user, to enable the use of the keyboard even if the tabletop is lowered or almost completely horizontal.

The table is provided with electrical connectors (8) fixed inside the lateral part of one of the two legs. These connectors are connected with two cables, one of them (9) to be connected to the power mains through an outlet placed at the floor or wall of the room and another (10), providing an extension for connection with neighboring apparatuses, supplying electrical power to a group of identical apparatuses.

While a particular embodiment of the invention has been described, it will be understood, of course, that the invention is not limited thereto since many obvious modifications can be made without departing from the scope and the spirit of the invention. For example, it will be appreciated by those skilled in the art, that the tilting mechanism may use only one coupling rod, with a first coupling (14) that will be preferably be centralized between the two sides of the tabletop, the second coupling (15) being fixed in a point localized approximately at the same plane of the two lateral guides (12). In any case, whether one or two coupling rods are used, this (or these) will move in a plane orthogonal to the tabletop.

1. Computerized school desk for education and many other applications, the desk comprised of an apparatus comprising a rigid support structure, a tabletop comprising a transparent touch screen or tablet, operated by touch or stylus, under which is positioned a flat panel electronic display, which moves together with the screen or tablet; the apparatus being provided with a tilting mechanism to move the tabletop from a horizontal position to a vertical position and any intermediate position between the horizontal position and the vertical position.

2. Desk, as claimed in claim 1, wherein said tilting mechanism comprises at least one coupling rod possessing a first extremity is rotationally coupled to an intermediate point between the front and rear edges of said tabletop and a second extremity is coupled rotationally to a fixed point in said structure, said coupling rod moving in a vertical plane orthogonal to the plane of the tabletop, as well as two elements attached to a proximal region of the front and rear edges of said tabletop coupled to enable a sliding movement in two parallel longitudinal, substantially horizontal guides, placed at a height approximately equal to a height of the tabletop of a table or school desk.

3. Desk, as claimed in claim 2, further comprising sliding pulleys or sliding shoes installed at the proximal extremities of sides of said tabletop.

4. Desk, as claimed in claim 1, wherein said transparent screen comprises functionalities of a touch screen or tablet.

5. Desk, as claimed in claim 1, wherein said apparatus, moreover, is suitable to be used as a conventional table and desk.

6. Desk, as claimed in claim 1, wherein it comprises under said tabletop an additional shelf-like surface to be used for objects of any nature, including conventional keyboard and mouse.

7. Desk, as claimed in claim 6, wherein said shelf-like surface is partially movable by sliding horizontally to a position closer to the user.

8. Desk, as claimed in claim 1, wherein the tabletop has variable tilt, adjustable according to needs of the user.

9. Desk, as claimed in claim 1, wherein said tilting mechanism comprises a damper.

10. Desk, as claimed in claim 1, further comprising means to install a computer or other information processing device, autonomous or connected to a network, as well as books, copybooks and other objects.
